(19) United States
(12) Patent Application Publication
(10) Pub. No.: US 2022/0368835 A1
(43) Pub. Date: Nov. 17, 2022

(54) DISPLAY WITH INTEGRATED CAMERA

(71) Applicant: Ji SHEN, San Diego, CA (US)

(72) Inventor: Ji SHEN, San Diego, CA (US)

(21) Appl. No.: 17/686,284

(22) Filed: Mar. 3, 2022

Related U.S. Application Data
(60) Provisional application No. 63/155,994, filed on Mar. 3, 2021.

(51) Int. Cl. H04N 5/232; H04N 5/225; H04N 5/91; H04N 5/77; H04N 5/262; G09G 3/3208; G09B 5/06

(52) U.S. Cl. CPC H04N 5/23299; H04N 5/2253; H04N 5/91; H04N 5/23293; H04N 5/77; H04N 5/2628; H04N 5/2257; G09G 3/3208; G09B 5/06; G09G 2360/145; G06F 3/1454

(57) ABSTRACT

The present invention provides an interactive display screen integrated with an image capture device optimized to capture the user, the user's correct gaze, and information inputted on or through the interactive display screen. The present invention does not require extraneous video production equipment or technical expertise to operate while providing a compact and easily transportable system. The display screen is transparent such as an organic light emitting diode (OLED) display, with an optional touchscreen. The display screen may display digital photos or other multimedia objects that a user can annotate or otherwise manipulate. The device captures the displayed multimedia information and combines it with a video stream captured from the image capture device. The present invention also implements a display screen with a display cycle that is offset by 180 degrees from the capture cycle of the image capture device.

The present application claims priority to U.S. Provisional Patent Application No. 63/155,994, filed on Mar. 3, 2021, and entitled “Display With Integrated Camera.”

### BACKGROUND OF THE INVENTION

### 1. Field of Invention

The invention relates to interactive displays.

### 2. Description of Related Art

Today's students are growing up in a technology-rich environment. Schools are turning to interactive learning to inspire students and bolster teacher-student relationships. Further, businesses are relying on technology to enhance the exchange of ideas. There is very little interaction when a person is giving a presentation or a lecture with a traditional whiteboard or chalkboard as their back is to the audience. Important points may be lost, and listeners may be easily distracted.

Meanwhile, handwriting remains an indispensable tool for teaching and conveying information, for example, to students in a classroom, professionals in a business meeting, scholars at a conference, or anyone who wants to present to an audience. Traditionally, when an instructor, teacher, or presenter writes on a surface, it is often a whiteboard with a dry-erase marker, a blackboard with chalk, an interactive digital panel display with a stylus or hand/finger gestures. The whiteboard, blackboard, or other surface is typically mounted or stationed along a room wall. For example, teachers often lecture at the head of a room with a whiteboard mounted behind them. A significant drawback to this orientation is that it requires the teacher or presenter to turn their back to the audience to write on the board.

Smart boards, Lightboards, or interactive displays include user-facing cameras where a user can write on and record their writings. For example, laptop computers have a camera oriented toward the user. Typically, these cameras are located at the center of the bezel above the screen. Ideally, cameras would be located on a monitor directly in a participant's line of sight. This location would be near the middle of the monitor for participants to converse with each other. However, placing a camera in front of a display monitor and in the middle would block part of the display, create a viewing distraction, and not enable proper conferencing.

Existing videoconferencing system configurations allows individuals to conduct a videoconference where each participant's device captures a video sent to the other participants. The participants view each other while conversing remotely. A presenter must train themselves to look above the screen and into the camera lens to appear to be looking at another participant. As such, a common problem is that the videos produced from such devices give the impression that each participant is looking below the camera because they typically look at the device's screen and not the camera. Additionally, because video conferencing windows must appear inside of a screen, participants almost always appear to be looking down or sideways. This detracts from the personal experience because the “eye-to-eye” contact is not maintained.

Furthermore, because eye-to-eye contact is not maintained during video recordings due to the separation of the camera and display screen locations, creating videos for playback lack engagement. Video recordings do not appear natural since there is no eye contact and during video conferencing, participants are not able to view each other in the eyes. Research has shown the importance of humans to view each other in the eyes especially during conversations to convey sincere and amicable intentions. Specifically, in the business setting, during negotiations, or even remote court hearings, providing participants eye-to-eye contact encourages a more engaging and productive conversation.

In light of these challenges in the field, there is a need for a presentation device with an integrated camera oriented and located such that the presenter's gaze is directed to the camera while viewing the display screen. To correct eye-to-eye contact, promote more productive conversations, and create more engaging video presentations, a video camera or image capture device is embedded behind a display screen, preferably transparent. Advantageously, the video camera is either at a fixed location near the center of the display screen or enables a pan-tilt-zoom motion to be in the site line of a user.

### SUMMARY OF THE INVENTION

The present invention overcomes these and other deficiencies of the prior art by providing an interactive display screen integrated with a video camera optimized to capture the user, the user's correct gaze, and information inputted on or through the interactive display screen. In an embodiment of the invention, a presentation device comprises a transparent display screen with an integrated video camera optimized for the display screen. A presenter conveys information on one side of the display screen, as if writing on a whiteboard. The video camera captures (or audience observes) the information from the opposite side of the display screen. The display screen comprises a light source to inject light into an edge of the display screen to illuminate the display screen's information. A user writes or draws information on the display screen. The present invention does not require extraneous video production equipment or technical expertise to operate while providing a compact and easily transportable system. The display screen is transparent such as an organic light emitting diode (OLED) display, with an optional touchscreen. The display screen may display digital photos or other multimedia objects that a user can annotate or otherwise manipulate. The device captures the displayed multimedia information and combines it with a video stream captured from the video camera.

In another exemplary embodiment of the present invention, a presentation device comprises a transparent display screen comprising a display cycle characterized by oscillating periods of displaying visual information and not displaying visual information at a predetermined display frequency, an image capture device oriented in a direction toward to the transparent display screen and comprising an image capture cycle characterized by oscillating periods of capturing visual information and not capturing visual information at a predetermined capture frequency, wherein the display cycle of the transparent display screen is offset by 180 degrees from the image capture cycle of the image capture device.

In another embodiment, the image capture device is movable about a vertical axis and a horizontal axis; and pivotable about the vertical and horizontal axis. In another embodiment, the image capture device's orientation or position is periodically adjusted to optimize its perspective relative to a user's gaze. In another embodiment, the invention further comprises a photoelectric sensor configured to detect the display cycle or the display frequency of the transparent display screen. In an embodiment, the image capture frequency or the image capture cycle is periodically adjusted based on an output of the photoelectric sensor. In another embodiment, the transparent display screen further comprises a touch-sensitive panel.

The foregoing and other features and advantages of the invention will be apparent from the following, a more detailed description of the invention's preferred embodiments and the accompanying drawings.

### BRIEF DESCRIPTION OF THE DRAWINGS

For a complete understanding of the present invention and advantages thereof, reference is now made to the ensuing descriptions taken in connection with the accompanying drawings briefly described as follows:

FIG. 1 illustrates a perspective view of a presentation device according to an embodiment of the invention.

FIG. 2 illustrates a perspective view of a presentation device according to an embodiment of the invention.

FIGS. 3, 3A, 3B, and 3C illustrate an exemplary display with integrated camera, according to an embodiment of the invention.

FIG. 4 illustrates an exemplary system for capturing video on a display with integrated camera, according to an embodiment of the invention.

FIG. 5 illustrates an exemplary system for capturing writing and transmitting the writing to viewing devices, according to an embodiment of the invention.

Throughout the drawings, identical reference characters and descriptions indicate similar, but not necessarily identical, elements.

### DETAILED DESCRIPTION OF PREFERRED EMBODIMENTS

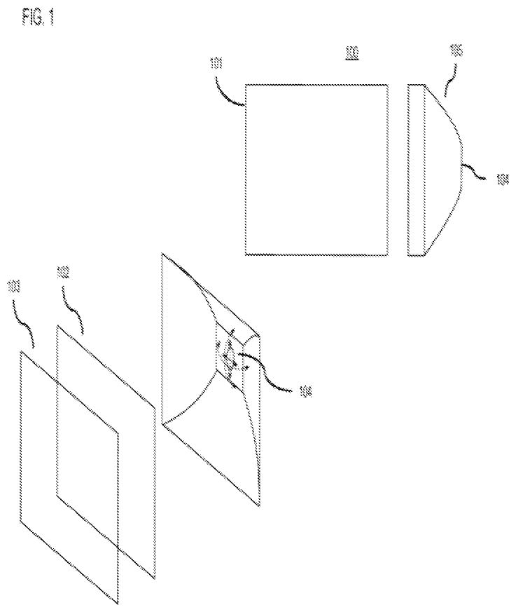

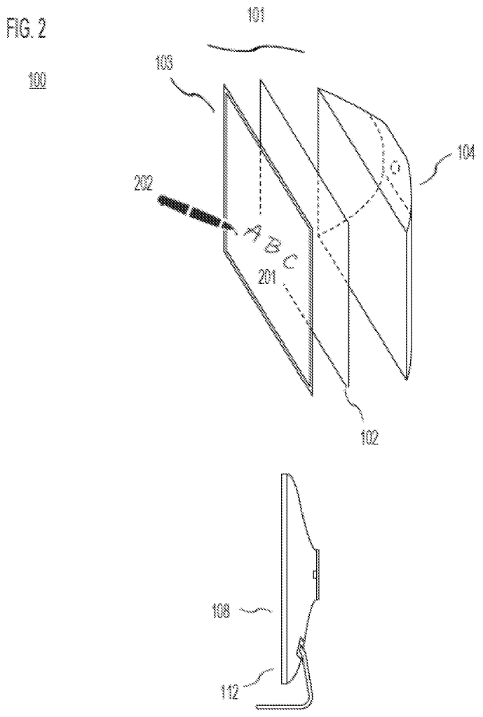

Preferred embodiments of the present invention and their advantages may be understood by referring to FIGS. 1-5. The described features, structures, or characteristics of the invention may be combined in any suitable manner in one or more embodiments. It will be apparent to those skilled in the art that modifications and variations can be made to the present invention without departing from the invention's spirit and scope. Thus, it is intended that the current invention cover all modifications and variations consistent with the scope of the appended claims and their equivalents.

The present invention provides a solution for capturing audio and visual information presented on transparent, semi-transparent, or translucent display screens while permitting a user or presenter (writing on the screen) to face an audience and/or a video camera. For simplicity, a display screen or writing surface with transparent, semi-transparent, or translucent properties is referred to herein as a display screen, a transparent display screen, a transparent writing surface, or an interactive display screen. The display screen may be any digital displays such as liquid crystal displays (“LCD”), transparent liquid crystal displays (“TLCD”), and transparent organic light-emitting diode (“OLED”) displays, referred to as organic electroluminescent diode displays. An advantage of using a display integrated with a transparent writing surface, is that multimedia information is displayed while a user simultaneously writes or draws on the display. For example, a user annotates rich media, including pictures, videos, or other information on a display screen with an integrated image capture device or video camera to capture the user's annotation and the rich media. The present invention also provides an integrated image capture device configured and oriented to produce a video stream of a user where the user appears to look into the image capture device with the correct gaze, preserving eye-to-eye contact.

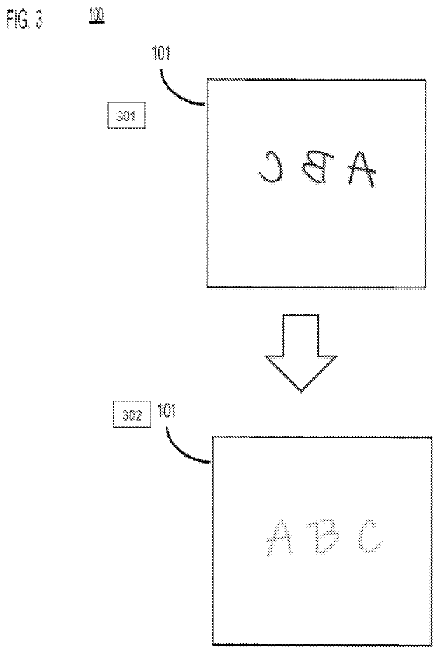

FIGS. 1 and 2 illustrate perspective views of a presentation device 100 according to an embodiment of the invention. The presentation device 100 comprises a transparent display screen 101 that encompasses a touch-sensitive panel 103 that acts as a writing surface and an OLED display 102. The touch-sensitive panel 103 is also referred to herein as the writing surface for ease of reference. The display screen 101 is any rigid, semi-rigid, or flexible material that is substantially, if not completely transparent. Substantially transparent refers to a degree of transparency sufficient to convey information presented on one side of the display screen 101 to the opposite side of the display screen 101. As noted above, the term transparent as used herein includes semi-transparent and translucent properties for ease of reference, specifically referring to OLED displays. The presentation device 100 further comprises an image capture device 104 coupled to the cover 105.

The image capture device 104 is any type of video capture device or video camera. For example, the image capture device 104 is a document camera, a single-lens reflex (“SLR”) camera, a digital SLR (“DSLR”) camera, a mirrorless camera, a digital camcorder, or a sports or action camera. The integrated image capture device 104 may be detachably coupled as a modular camera to the cover 105. The image capture device 104 is further configured such that its orientation can be adjusted. In such an embodiment, the image capture device 104 may pivot or move about one or more axes. The image capture device's 104 orientation may be adjusted up-and-down and left-to-right. Meanwhile, the presentation device 100 or an external computer attached thereto may cause the image capture device 104 to be adjusted periodically. In such an embodiment, the image capture device 104 may be configured to follow or track the presenter's eyes or face. In this way, the present invention ensures the image capture device 104 is always pointed at the user.

Furthermore, in one embodiment, the image capture device 104 is located behind the display screen 101 at a fixed location near or at the center of the display screen 101. In another embodiment, the image capture device 104 is located behind the display screen 101 and features a pan-tilt-zoom motion. Pan-tilt-zoom herein refers to an image capture device 104 with built in mechanical parts that allow for swiveling left to right, tilting up and down, and zooming in and out. Typical ranges of motion include 180 to 360 degree views and capture areas for video recording. Pan-tilt-zoom is advantageous because it is thin enough to be placed in and/or behind the display screen 101 since it does not physically move to capture a video. Advantageously, users can control the image capture device's 104 motions remotely via a viewing device, computing device including a phone, iPad, or tablet, and/or another similar device. Users can use an application to turn on, control movements of, and select what to capture on the image capture device 104.

Presentation device 100 comprises a display screen 101, an image capture device 104, and cover 105. In some embodiments, the display screen 101 comprises a touch-sensitive panel 103. Exemplary touch-sensitive panels 103 comprise an infrared or capacitive touch panel. The display screen 101 also embodies an OLED display 102. The presentation device 100 comprises an image capture device 104 positioned by cover 105. The image capture device 104 may be further configured to move and/or rotate about one or more axes. In some embodiments, image capture device 104 is pivotable about two axes, i.e., up-and-down, left-and-right (indicated by arrows). Additionally, image capture device 104 may be configured to adjust its position relative to display screen 101. For example, image capture device 104 may be configured to move vertically and horizontally instead of or in addition to being pivotable. Although not shown, image capture device 104 may be configured to move closer to or farther from the display screen, i.e., movable about the z-axis. By achieving more degrees of freedom, the image capture device can more accurately adjust its position and viewing angle, which helps ensure the user is always looking at image capture device 104. In this way, the movable image capture device 104 enhances the presentation experience. Although image capture device 104 may be shown and described as orientable about four axes, any number of axes, including six, may be utilized without departing from the contemplated embodiments. The presentation device 100 or another external computing device coupled thereto may control the direction or orientation of image capture device 104.

While in use, the image capture device 104 is orientated in a direction towards the display screen 101. With this orientation, the image capture device 104 captures the information on the writing surface 103 in the form of multimedia information, i.e., video. Because the information on the writing surface 103 is marked on the side opposite the image capture device 104, the writing will be reversed when viewed from the audience's and image capture devices' 104 perspectives. Accordingly, the multimedia information captured by the image capture device 104 is processed to reverse or flip the image/multimedia information about a vertical axis. Thereby reorientating the image/video in a manner that appears proper/correct to an audience member. Although multimedia information may be discussed herein in the context of a video stream (with or without audio), multimedia information also includes photos, still images, video stills/frames, video images, and video streams, either compressed or uncompressed, without departing from the contemplated embodiments.

In an exemplary embodiment, the present invention provides an image capture device embedded within a display screen. In an embodiment, the image capture device 104 may be integrated into the display screen 101. In such an embodiment, and as previously noted, the display screen 101 may have one or more image capture devices embedded into the display 101 that are optimized for use with the display. In such a configuration, the user can look at the display screen, and it will appear as if the user is looking into the eyes of the person receiving the video stream.

Providing an integrated image capture device 104 has several advantages over the prior art. Notably, the field of view (“FOV”), i.e., the amount of visible area, is tailored to specific applications. For example, the FOV includes the writing surface 103 but does not include other extraneous objects. Tailoring the FOV may be accomplished in the image capture device's 104 hardware by, for example, having an optical sensor 117 (not shown) with a predetermined size to match that of the writing surface 103. Tailoring the FOV may also be accomplished by optimizing the distance between cover 105 and the display screen 101, or in post-production, by digitally cropping the captured video to excise unwanted portions. Another optimized parameter is the exposure, i.e., the amount of light per unit area reaching the surface of an electronic image sensor 117. The exposure is adjusted by shutter speed, lens aperture, sensor sensitivity, or scene luminance. An additional optimized parameter is the depth of field, i.e., the distance between the closest and farthest objects in a photo or video stream that appears acceptably sharp. If the image capture device's 104 depth of field is too shallow, the writing surface 102 or the user, but not both, will be in focus, detracting from the acceptability of the visual experience provided by the present invention.

Furthermore, the display screen 101 is embodied by a sheet of glass. Preferably, the glass is tempered to provide strength and add safety if the glass display screen 101 breaks or shatters. However, the display screen 101 can be a sheet of acrylic, plexiglass, polycarbonate, cellophane, latex, polyurethane, melamine, vinyl, polyester, or any combination thereof. In some embodiments, the display screen 101 and the writing surface 103 are a single layer of homogenous material, or in other embodiments, the display screen 101 and the writing surface 103 are multi-layered with two or more sheets of material, which may be different or the same. Again, whether a single layer or multi-layered, a layer may comprise an OLED display 102. In such multi-layered embodiments, one or more of the outer layers may be a protective layer easily interchangeable/replaceable to guard against scratching or damaging any of the layers. In such an embodiment, the protective layer can be thin and inexpensive so that when damaged, it can be easily changed.

In another embodiment of the present invention, the display screen 101 comprises a touch-sensitive interface or touchscreen, the identification and implementation of which are apparent to one of ordinary skill in the art. A user may use a stylus, digital pen, or various hand and finger gestures to interact with a graphical user interface facilitated by the touchscreen to draw, annotate, or otherwise control media displayed on the display screen 101. In such an embodiment, the multimedia information captured by the image capture device 104 is processed independently of or in conjunction with the markings captured by a digital whiteboard software module 345. Additionally, in such an embodiment, the interactive display 108 controls one or more functions of the image capture device 104.

Although the display screen 101 is shown as rectangular, any shape or orientation may be implemented. For example, the display screen 101 may be circular or ovular in shape. Also, the display screen 101 can be curved to focus light directly on the audience or image capture device 104. In a curved embodiment, the curvature may be optimized for the field of view of the image capture device 104, for example, to capture the entire display screen 101 or to preserve the aspect ratio of objects or information displayed on the display screen 101 when displayed on a separate display (not pictured).

The presentation device 100 may optionally utilize one or more displays for displaying the video captured by the image capture device 104. Such a display can be any type of display, the identification and implementation of which are apparent to one of ordinary skill in the art. Exemplary displays include electroluminescent (“ELD”) displays, liquid crystal display (“LCD”), light-emitting diode (“LED”) backlit LCD, thin-film transistor (“TFT”) LCD, light-emitting diode (“LED”) displays, OLED displays, AMOLED displays, plasma (“PDP”) display, and quantum dot (“QLED”) displays. Additionally, the displays can be standalone units such as televisions or computer monitors or integrated into other devices such as cellular telephones and tablet computers. The one or more displays may further comprise touch-sensitive displays capable of interacting with a user's finger or an electronic/digital pen.

Meanwhile, the cover 105 comprises any suitable material, for example, any rigid or semi-rigid material including, but not limited to, wood, plastic, metal, or any combination thereof. The cover 105 can also be angled to act as a frame and shield light pollution from affecting the capturing of media content from the image capture device 104. The cover 105 can also be flat with no angular shape. Meaning, it is pressed flat or matted against the display screen 101 that encompasses the OLED display 102 and touch panel 103. The presentation device 100 utilizes specific types and delivery systems for light to enhance the viewer's or user's experience. In an embodiment of the invention, the cover 105 comprises an embedded light source such as one or more LEDs to inject light into the display screen 101. The effect highlights dry-erase ink, preferably neon dry erase ink, deposited on the writing surface 103. The injected light may be in the visible spectrum or outside the visible spectrum, such as ultraviolet, i.e., blacklight or infrared. In another embodiment, the display screen 101 is one OLED display 102 with a touch panel 103 and light from the OLED display 102 illuminates the dry-erase ink deposited on the writing surface 103. Thus, in this embodiment, the cover 105 may not comprise LEDs.

In an exemplary embodiment of the present invention, the cover 105 houses a computer that features a processor, memory, and computer program code. The computer housed within the cover 105 runs software and computer program code that controls all of the interactions and functioning of the presentation device 100. The cover 105 also can encompass the display screen 101 to act as a monitor where a control board or motherboard controls the presentation device's 100 features from the display screen 101. In addition, a keyboard is either wirelessly connected or wired to the presentation device 100 and controls the display screen's 101 functions.

In some embodiments, the cover 105 has a predetermined depth to ensure that the image capture device 104 captures the entire display screen 101 within its field of view. In an alternate embodiment, the image device 104 may be disposed on a surface of the display 101.

The presentation device 100 is preferably configured to be free-standing, e.g., set on a table or another horizontal surface. In such an embodiment, the presentation device 100 comprises a stand that allow display screen 101 to sit in an upright orientation. The display screen 101 also can be adjustable in height, direction, orientation, and can swivel about a center axis. It can be angled to provide an optimum viewing angle by a user. Additionally, a microphone can be disposed on the display screen 101, a connected mouse, and a battery pack to add portable computing. Connected herein and above refers to Bluetooth, WIFI, or other similar technologies to communicate and link devices together.

In an embodiment of the present invention, the ink used with the writing surface 103 is tailored to maximize visibility with the injected light. Additionally, a built-in light source has the advantage of having its incidence angle (i.e., the angle at which the light interacts with the display screen) predetermined to maximize visibility to a viewer while minimizing its intrusion to the presenter. In such embodiments where particularized wavelengths of light are injected, the image capture device 104 or accompanying software or firmware may have filters pre-installed or preloaded that would filter out unwanted colors/effects from the captured multimedia information. In other words, one or more filters correspond to the frequency of light injected. The image capture device 104 may implement polarization filters as well. For example, in the case of a confidence monitor being present, the implementation of which is apparent to one of ordinary skill in the art, a polarization filter eliminates reflections on the writing surface 103 from the confident monitor.

In some embodiments, the injected light is used to illuminate a display embedded within the display screen 101. For example, LCDs require backlighting to ensure images displayed thereon are visible. The injected light, for example, operates as the backlight for an LCD display embedded within display screen 101. To achieve this, the embedded light sources can emit different types of light. For example, the embedded light sources emit any range of colors to enhance the visibility of ink drawn on writing surface 103 and also inject white light, or other wavelengths, to serve as the backlighting for an embedded LCD display. In another embodiment, there is one or more embedded light sources that provide backlighting.

In another embodiment of the present invention, the presentation device 100 comprises a control panel 112 used to control the presentation device 100. The control panel 112 may be configured to control image capture device 104 (or various attributes thereof, e.g., power, exposure, contrast, saturation, DOF, and FOV). The control panel 112 may also control light sources integrated into various parts of the presentation device 100. In some embodiments, the control panel 112 is embodied by a separate tablet, cellphone, or another smart device. In such an embodiment, the control panel 112 may further comprise an interactive display configured to view or control the multimedia information captured by the image capture device 104, participate in video conferencing, and the like. In other embodiments, the control panel 112 comprises an integrated display that may also serve as a confidence monitor. In some embodiments, and with reference to FIG. 2, the controls discussed with respect to the control panel 112 is implemented by displaying a graphical user interface (“GUI”) on the display screen 101. In such an embodiment, the user manipulates the controls via the GUI for the added benefit of minimizing the need for extraneous equipment and moving components. Meaning, the GUI can be used with a touch screen implementation on the display screen 101 where a user points, drags, pinches, moves, and controls the GUI and display screen 101. Additionally, the GUI is customized based on the intended use of the presentation device 100. Moreover, the control panel 112 and GUI can be controlled through software downloaded on the presentation device 100. In a non-limiting example, the software downloaded on the presentation device 100, and optionally via the control panel 112 and the GUI control and enable the injected light, the filtering of light, touch screen use, and display screen 101 effects such as color rendering, face filters, screen filters, and screen backgrounds. The software downloaded on the presentation device 100, and optionally via the control panel 112 and the GUI also control and enable facial recognition security capabilities through the image capture device 104, full color spectrum light filtering and rendering from the injected light, image rendering, digital media content rendering, and enhancing media content. In addition, the software downloaded on the presentation device 100, and optionally via the control panel 112 and the GUI control and enable video conferencing capabilities and is provides an efficient interface that interacts with common video conferencing software including, but not limited to Zoom, Microsoft Teams, Skype, Google, and other common platforms.

The presentation device 100 facilitates built-in video conferencing in an embodiment of the invention. One or more of the processes enable the user to engage in bi-directional video presentations. In such an embodiment, a user initiates a video teleconference wherein image capture device 104 captures video to be shared with other video teleconference members. Video streams showing audience members or other users, i.e., other members of a videoconference, can be displayed on display 101.

In another exemplary embodiment, the presentation device 100 comprises an interactive display 108. The display 108 may include a user interface that allows the user to control one or more aspects of the present invention. For example, the interactive display 108 can enable the user to view the video captured by the image capture device 104 and adjust specific settings, for example, the exposure. The interactive display 108 may also allow a user to control light sources (not shown) integrated into the cover 105.

The present invention also facilitates image insertion. In an embodiment of the invention, the image capture device 104 or a computer coupled to it superimposes a computerized image or video onto the captured video. For example, a computerized image can be a double-stranded DNA molecule. A user or presenter sees the double-stranded DNA molecule on the display screen and writes on top of the image. A user writes or draws information on the writing surface 103 on top of the, for example double-stranded DNA molecule, on the display screen. The image capture device take a video having both the writing and annotations and the double-stranded DNA molecule. The software can send the video stream to other users on a network via WIFI, Bluetooth, or other similar connectivity technologies. This sending can occur in real-time, at a later time, or at another pre-determined time after the video is captured and recorded.

In an embodiment of the present invention, a presenter or other user utilizes a pen or marker 202 to mark a writing 201 on the display screen 101. The user (not shown) draws “A B C” 201 on the display screen 101. The image capture device 104 captures video that includes the writing 201. Notably, the writing 201 is marked on the writing surface 102 on the side opposite to that of the image capture device 104, and thus, when viewed from the image capture device's 104 perspective, the writing 201 appears backward.

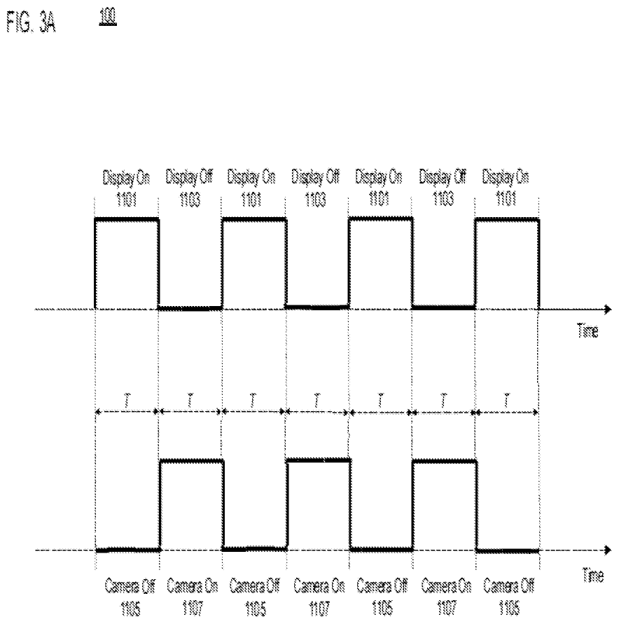

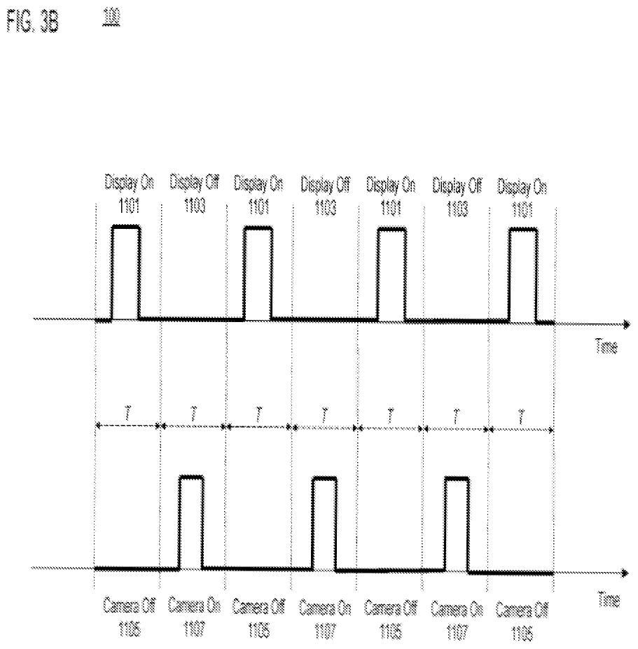

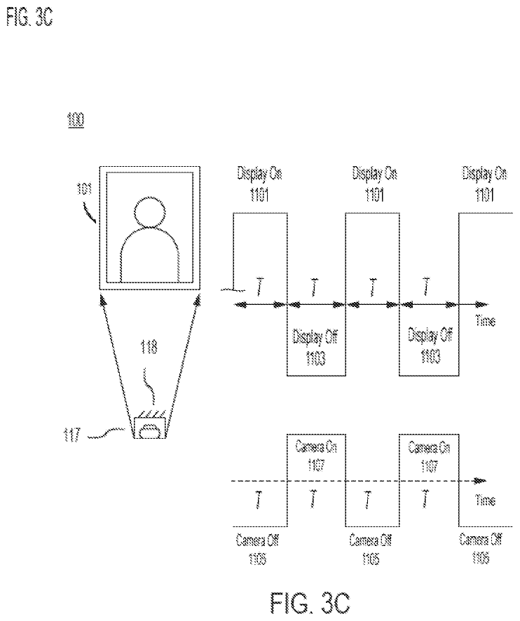

Continuing and with reference to FIG. 3, the image capture device 104 captures the writing 201 from a perspective opposite to that of the writer/presenter (not shown). If the video captured by the image capture device 104 were viewed without processing, the images would appear reversed. For example, if displayed without reorientation, the writing 201 would appear as shown on display 301. However, the presentation device 100 (or a separate computer or display coupled to it) processes the multimedia information captured by the image capture device 104 to reorientate, i.e., flip, it about a vertical axis. Once processed, the writing 201 appears correctly orientated and in the writer's direction, as shown on display 302. In this way, the device 100 captures multimedia information (e.g., audio and video) from a perspective opposite the writer/presenter. Still, it produces the video rearranged in the correct orientation in real-time or near-real-time, i.e., with an imperceptible delay to an ordinary human observer. In addition to reorientating the multimedia information, the device 100 can also process the multimedia information to effectuate other desired outcomes, such as adjusting the exposure, brightness, focus, saturation, sounds, DOF, FOV, or other audio-visual effects. The device 100 can also process the multimedia information by compressing the video or sound stream to decrease latency, decrease the storage space required, or facilitate transmissibility, the implementation of which is readily apparent to one of ordinary skill in the art.

In some embodiments, presentation device 100 utilizes one or more external computers with applications loaded thereon to control one or more of the processes to implement the embodiments described here. In other embodiments, the presentation device 100 comprises an on-board computer running applications to implement one or more processes described herein.

For example, and with reference to FIGS. 3A-3C, image capture device 104 and the OLED embedded into the display screen 101 are configured to be out of phase with each other. In such an example, the LEDs of the OLED display screen 101 fire when the image capture device 104 is in-between frame captures. The LEDs do not interfere with the video stream captured by image capture device 104. Because OLED displays produce video images by actively emitting light at each pixel, OLED displays can be made with protective sheets of glass disposed on the front and back of the OLED display. Backlighting is not required. Thus, with a transparent display screen 101, video images can be displayed while a user looks through the display screen 101 to see other participants on the opposite side of the display screen 101. As depicted in FIG. 3A, the LEDs are enabled and fire or turn on, to create a transparent effect. Meaning, the image capture device 104 appears to be transparent and not located near or at the center of the display screen 101. Beneficially, a user does not have a distracting image or camera in their gaze and users now make eye-to-eye contact with other participants. Denoted as “Display On” at step 1101, image capture device 104 is not capturing information, denoted as “Camera Off” at step 1105. These oscillating periods of “Display On” and “Display Off” are referred to as the display cycle. Conversely, when the LEDs are firing, denoted as “Display On” at step 1103, the image capture device 104 is capturing information, denoted as “Camera On” at step 1107. Such a cycle can be continuously implemented such that image capture device 104 does not capture information displayed on display screen 101. The depicted cycle can be implemented over some time interval T For example, in an embodiment where display screen 101 refreshes at a rate of 120 Hz, the time interval T will be approximately 8.33 milliseconds. Any time interval may be applied without departing from the contemplated embodiments by, for example, implementing the following relationship:

$$T = \frac{1}{Refresh Rate}$$

As used in the previous example,

$$T = \frac{1}{Refresh Rate} = \frac{1}{[ 120 Hz ]} = 0.0 \; 08333 seconds = 8.333 ms$$

Using the exemplary relationship noted above, any refresh rate can be used. For example, refresh rates of 24 Hz (24 fps), 30 Hz (30 fps), 60 Hz (60 fps), 75 Hz (75 fps), 120 Hz (120 fps), 144 Hz (144 fps), and 240 Hz (240 fps) can be implemented without departing from the contemplated embodiments. Because of the high refresh and capture rates, when Display On occurs, the OLED pixels display an image and when Display Off occurs, the display screen 101 is clear or turned off. The effect is that the human eye receives the visual effect of seeing both the video and the objects on the opposite side of the display screen. As such, because of the oscillating on-off cycles, the image capture device 104 does not appear to a user even though it may be located at or near the center of the display screen 101. The image capture device 104 is effectively transparent or see through for other participants or users, for example on a video conference, view the user or other users directly in the eyes.

The Display On 1101 and the Display Off 1103 or the display cycle is generally characterized by the oscillating periods of the LEDs of the OLED display 101 firing. Similarly, the Camera Off 1105 and Camera On 1107 may be referred to as the capture cycle and is generally characterized by the oscillating periods of the image capture device 104 capturing visual information and not capturing visual information.

Although the image capture device 104 is shown as beginning its capture immediately after the LEDs of OLED display 101 complete their firing cycle, other embodiments may include a gap in time between the alternating cycles. For example, and as depicted in FIG. 3B, there may be some time between one component completing its cycle and another component beginning its cycle. This may be dictated by the particular hardware or software utilized to implement the contemplated embodiments. The display on cycle may be detected via a sensor 117 mounted to a surface of the OLED display 101 that detects light from the firing of one or more of the display's LEDs. For example, the sensor 117 may be a photoelectronic device, which is coupled to control circuitry for the image capture device 104. By implementing a predetermined threshold for the output of the photoelectronic device, the control circuitry can cycle the image capture device 104 off and on synchronously with the respective on and off firing of the LEDs in the OLED display 101. Such a configuration permits the use of an off-the-shelf OLED without any special knowledge of their inner electronic workings, which are usually proprietary.

Continuing and with reference to FIG. 3C, the display cycle may be detected by one or more sensors 117. For example, a photoelectric sensor 117 may be implemented that detects when the LEDs of the OLED display 101 are firing and when they are not. In this way, the present invention can detect the display cycle and, in turn, adjust the capture cycle or capture frequency of the image capture device 104. As an exemplary example in FIG. 3C, the oscillating periods occur at 8.33 ms or 120 Hz.

Additionally, the presentation device 100 may comprise one or more sensors 117 and other hardware and software that enable the presentation device 100 to track the eye position and/or the head position of the user, the implementation of which will be readily understood by one skilled in the art. In such an embodiment, the presentation device 100 periodically reorients the image capture device 104 to be pointed at the user's eyes and/or head. In this way, the image capture device 104 is continuously oriented at the user's eyes or head, further enhancing the viewing experience. Thus, helping maintain the human “eye-to-eye” contact that is lost using conventional videoconferencing techniques. To implement such a presentation device 100, the image capture device 104 and the display 101 may be optimized to work in conjunction with each other.

Furthermore, in another embodiment of the present invention, the presentation device 100 comprises a video driver and related hardware (“video module”) for controlling the video displayed on a transparent or translucent display screen 101. For example, the video module inserts one or more blank frames into a video stream at certain intervals that are synchronized with a shutter of the image capture device 104. Every time a blank frame is displayed on the display screen 101, the shutter of the image capture device 104 is open, i.e., the image capture device 104 captures an image of the display screen 104 with no video being present. The captured image would appear to be that of the presenter and anything written by the presenter on the display screen. On the next frame, an active video frame would be shown and the shutter 118 of the image capture device 104 would be closed. Hence, the image capture device 104 would not capture the video frame being shown. Such opening and closing would be repeated cycle after cycle. In other words, the opening of the shutter 118 is in phase with the blank video frames being displayed according to the above-mentioned rates. At 60 frames per second, the blank video frame is inserted every 16 milliseconds. The presentation device 100 adapts to any vendor, provider, or manufacturer of display screen. The presentation device 100, therefore, provides complete control over any display screen 101. In an embodiment of the invention, the shutter is a global shutter or electric shutter 118 that is connected to the sensor 117 to detect the capture and refresh cycle.

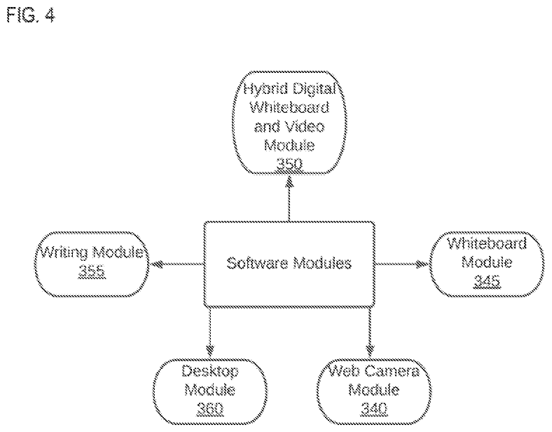

FIG. 4 illustrates modules embodied in computer code that are executed to run as software and can be embodied in an installed application. At least the following modules are executed as software in the present invention. A web camera module 340 allows the image capture device 104 to capture, record, save, and send video streams to participants. A digital whiteboard module 345 allows a presenter to mirror their screen and enables users to annotate on the shared whiteboard layer. A hybrid digital whiteboard and video module 350 creates a digital whiteboard layer with the video stream from the image capture device 104 blended and placed into one thumbnail or window view. A writing module 355 enables users and presenters to write on the display screen 101 and record their drawings. Finally, a desktop module 360 creates a user interface on the display screen 101 that simplifies running windows in a sorted view, grid view, or other view.

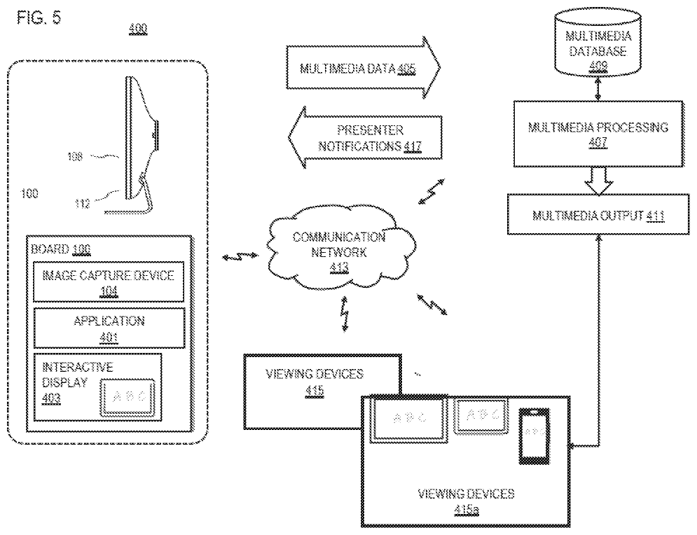

In another exemplary embodiment and with reference to FIG. 5, a system 400 captures writings 201 and transmits the information to viewing devices 415(a)-(n). The presentation device 100 comprises an integrated image capture device 104 and an application 401 loaded thereon and configured to control various aspects of the system or effectuate processes described herein. The presentation device 100 may further comprise a controller/interactive display 403. Once the image capture device 104 captures multimedia information, including the writing 201, e.g., a video, the multimedia information is transmitted for multimedia processing at step 407. The multimedia information can be transmitted across the communication network 413. As part of the processing, the system 400 reorientates a visual component about a vertical axis, as noted above. The system 400 stores the multimedia information in multimedia database 409, either before or after processing. Once processed, the multimedia information is outputted, at step 411, to various devices. For example, the processed multimedia information can be sent to viewing devices 415a-n. Such viewing devices 415a-n may include televisions, monitors, computers, desktop computers, laptop computers, kiosks, smartphones, portable electronic devices, tablets, or any other device comprising a display screen. One or more of the viewing devices 415a may communicate with other viewing devices 415n through the communication network 413 or directly, for example, via Bluetooth. In an embodiment utilizing built-in video conferencing, the viewing devices 415a-n may be participants in the teleconference along with the user/presenter using the presentation device 100. The communication network 413 may be the Internet or any computer network, the identification and implementation of which are apparent to one of ordinary skill in the art.

One or more of the viewing devices 415a can send information back to the system 400. In such an example, a user of the viewing device 415a can send, for example, a presenter notification 417 to the display screen 101 or other components thereof. The notification 417 can be displayed, for instance, on interactive display 403. In the context of a classroom setting, a student using viewing device 415a can, for example, send a question 417 to the instructor using display screen 101. The question 417 may then be displayed on display 403. The instructor may use interactive display 403 or application 401 to answer or cancel the question 417. The question 417 can also be displayed on one or more of the viewing devices 415n. Other students using the viewing devices 415n may also be able to answer/cancel the question 417 with or without input from the instructor using display screen 101.

While the invention has been described in connection with a number of embodiments and implementations, the invention is not so limited but covers various apparent modifications and equivalent arrangements, which fall within the purview of the appended claims. Although features of the invention are expressed in certain combinations among the claims, it is contemplated that these features can be arranged in any combination and order. The invention has been described herein using specific embodiments for illustrative purposes only. It will be readily apparent to one of ordinary skill in the art, however, that the principles of the invention can be embodied in other ways. Therefore, the invention should not be regarded as limited in scope to the specific embodiments disclosed herein; it should be fully commensurate in scope with the following claims.

We claim:

1. A presentation device comprising:
a display screen encompassing a touch panel disposed on the display screen;
a cover affixed behind the display screen;
an image capture device integrated into the display screen; and
a display cycle comprising oscillating periods of displaying visual information and not displaying visual information on the display screen.

2. The presentation device of claim 1, wherein the image capture device appears transparent to a user.

3. The presentation device of claim 1, wherein the image capture device is movable about a vertical axis and a horizontal axis.

4. The presentation device of claim 1, wherein the image capture device is pivotable about a vertical axis and a horizontal axis.

5. The presentation device of claim 1, wherein the image capture device is fixed near the center of the display screen.

6. The presentation device of claim 1, wherein the image capture device comprises a pan-tilt-zoom motion.

7. The presentation device of claim 1, wherein the display screen comprises an embedded OLED display.

8. The presentation device of claim 1, wherein the display screen is transparent.

9. A method of displaying visual information on display screens, the method comprising the steps of:
capturing media content via an image capture device;
displaying media content from the image capture device on a display screen; and
enabling a display screen's LEDs while simultaneously turning the image capture device off, the process being repeated at a rate while the image capture device captures media content in-between frame captures, wherein the image capture device appears transparent to a user.

10. The method of claim 9, wherein the image capture device is embedded into the display screen.

11. The method of claim 9, wherein the display screen comprises an OLED display.

12. The method of claim 9, wherein the rate at which the image capture device captures media content and refreshes occurs at a range of 24 Hz-240 Hz.

13. The method of claim 9, wherein the rate at which the image capture device captures media content and refreshes occurs every 8.33 milliseconds.

14. The method of claim 9, wherein the rate at which the image capture device captures media content and refreshes comprises at least one sensor to detect the capture and refresh cycle.

15. The method of claim 14, wherein the sensor comprises a photoelectric sensor to detect LEDs of the display screen.

16. The method of claim 9, further comprising the steps of:
detecting a display cycle;
adjusting a capture cycle of the image capture device; and
adjusting a capture frequency of the image capture device.

17. The method of claim 9, further comprising the step of:
inserting a blank frame into a video stream at intervals synchronized with a shutter on the image capture device.

18. A system for displaying visual information, the system comprising:
a presentation device that comprises an image capture device to record media content and present a video stream;
a video module that controls media content displayed on a display screen and inserts one or more blank frames into the video stream at intervals that are synchronized with a shutter on the image capture device; and
at least one viewing device that receives captured writings and information transmitted from the presentation device.

19. The system of claim 18, wherein the presentation device stores multimedia information in a multimedia database.

20. The system of claim 18, wherein multimedia information is transmitted across a communication network and processed to reorientate a visual component about a vertical axis.
